(19) United States
(12) Patent Application Publication
(10) Pub. No.: US 2005/0060810 A1
(43) Pub. Date: Mar. 24, 2005

(54) Combination ice scoop and bottle opening means

(76) Inventor: Jeff McKelvie, Huntington Beach, CA (US)

Correspondence Address: Christopher J. Whewell;Western Patent Group, 6020 Tonkowa Trail, Georgetown, TX, 78628, US

(21) Appl. No.: 10/668,130

(22) Filed: Sep. 24, 2003

(51) Int. Cl. B25F 1/00

(52) U.S. Cl. 7/110

(57) ABSTRACT

Provided herein is a multi-purpose implement useful in the beverage service industry which comprises a handle means having a first end portion and a second end portion, to which a scoop means is attached to the first end portion of the handle means, and to which a bottle opener means is attached to the second end portion of the handle means. An implement according to the invention increases the synergistic movements of a server such as a bartender by enabling them to use fewer motions during the procedure of serving a beverage which comprises filling a glass with ice to a desired level and subsequently opening a bottle containing a liquid beverage to be dispensed into the glass, and finally pouring the bottle contents of the bottle into the glass. By eliminating motions associated with the use of two separate tools, as was required by prior art methods, bartending is made more efficient through use of the present invention, which will be welcomed by the operators of establishments which serve large numbers of beverage-consuming customers in limited intervals of available time, thus increasing profits to the respective organizations.

### TECHNICAL FIELD

The present invention relates to implements useful in the food service industry. More particularly, it relates to an implement having a dual function, useful in preparing beverages for patrons for restaurants, bars, and other like establishments.

### BACKGROUND INFORMATION

Two separate, simple tools, namely container openers and ice scoops, are typically used in close physical proximity to one another in many every day situations in the food service industry. Container openers designed to remove crown caps from bottles or cans or to assist in the opening of “pull tab” cans have been incorporated into a variety of different devices. In their simplest form, bottle openers are a single separate tool. Frequently, bottle openers are incorporated into other devices, such as jacknives, in a fold-out fashion. Frequently, bottle openers are attached to the sides of ice chests, or other containers for beverages, to provide ready access to the bottle opener.

Ice scoops also typically are a separate item. Consequently, a person desiring to have both an ice scoop and a bottle opener on his person must carry two separate items. Although many situations exist when only a ice scoop is desired or only a bottle opener is desired, there are a large number of applications when it is desirable to have both a ice scoop and a bottle opener available together in the same place, such as in the case of a bar or nightclub setting. Thus, it is an object of this invention to provide a simple combined container opener and ice scoop that is inexpensive and simple to use. Accordingly, it is a preferred embodiment of this invention to provide an improved combination bottle opener and ice scoop.

It is another object of this invention to provide an improved bottle opener and ice scoop combination for use in conjunction with disposable ice scoops.

It is another object of this invention to provide an improved bottle opener with a handle for removably holding an ice scoop.

It is a further object of this invention to provide an elongated handle for a bottle opener which has an open-ended sleeve for removably holding a disposable ice scoop on the end opposite the end to which the bottle opener is attached.

In accordance with a preferred embodiment of this invention, a combination ice scoop and bottle opener is made with an elongated handle. This handle has a container opener member at one end and a ice scoop receiving pair of inwardly turned flanges on the other end for frictionally engaging a disposable ice scoop between the flanges.

### SUMMARY OF THE INVENTION

The present invention provides a multipurpose implement comprising: a handle means having an first end portion and a second end portion; a scoop means disposed at said first end portion of said handle means; and a bottle opener means disposed at said second end portion of said handle means. According to one preferred form of the invention, the bottle opener means comprises a slot disposed at the second end portion. According to a preferred form of the invention, the bottle opener means is cast-in to the implement as a whole. According to a preferred form of the invention, the implement is of singular construction. According to a preferred form of the invention, implement comprises a metal selected from the group consisting of: aluminum, zinc, copper, tin, and mixtures and alloys of the foregoing.

### BRIEF DESCRIPTION OF THE DRAWINGS

FIG. 1 is a perspective view of an implement according to one preferred form of the invention; and

FIG. 2 is a side perspective view of an implement according to one preferred form of the invention.

### DETAILED DESCRIPTION OF THE INVENTION

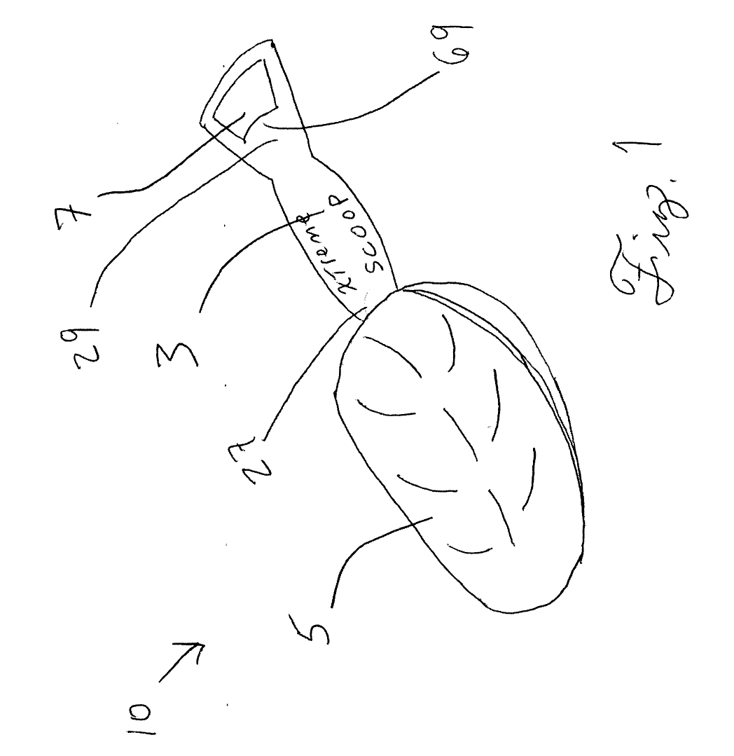

Referring to the drawings and initially to FIG. 1 there is shown in perspective view a multi-purpose implement 10 according to a preferred form of the invention which is a combination ice scoop and bottle opening means. In FIG. 1 there is a handle means 3 having a first end portion 27 to which a scoop means 5 is attached. The handle means 3 also has a second end portion 29 having a bottle opening means 7 attached thereto.

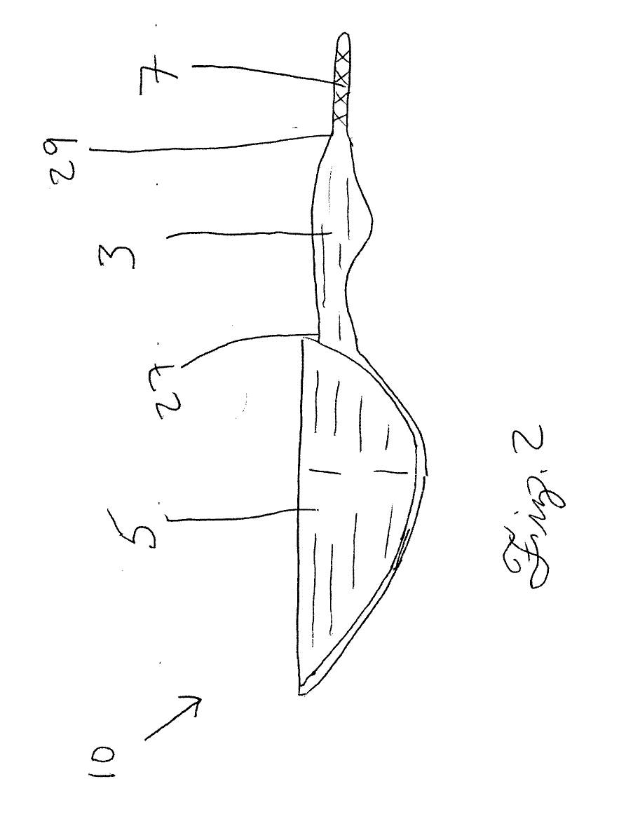

FIG. 2 shows a side perspective view of an implement according to the invention having a handle means 3 having a first end portion 27 to which a scoop means 5 is attached. The handle means 3 also has a second end portion 29 having a bottle opening means 7 attached thereto.

An implement according to the invention is preferably of singular construction, i.e. it is comprised of one solid piece of stock, such as being made from a metallic composition including aluminum, zinc, copper, tin, and mixtures and alloys thereof. According to a preferred form of the invention, the implement 10 is manufactured by a die casting process, and according to an alternate form of the invention, the implement is manufactured by a stamping process, these processes being well known to those skilled in the metalworking arts. An implement according to the invention is preferably comprised of die-cast zinc; however, zinc-aluminum alloys and polymers may be used as well. When the material of construction is selected to be a polymer, the implement is preferably manufactured by an injection molded process. Various polymers known to those skilled in the art may be utilized, preferably those having tensile strengths sufficient to render them qualified for long-term use in opening bottles without cracking, and a wide variety of polymers are known in the art which qualify for such use, as is readily determined by one of ordinary skill, including without limitation polymers selected from the group consisting of: polypropylene, polyethylene, polybutylene, polystyrene, styrene-butadiene-acrylonitrile (SBS), epoxy resins, and alloys of the foregoing.

Preferably, the handle means 3 is contoured as shown in FIG. 2 to be ergonomically fit into the hand of its human user, who may utilize the implement 10 for scooping ice cubes, crushed ice, or other similar substances from a storage bin in which they are normally contained. Typically, an ice scoop is left inside s bin of ice with the scoop portion submerged in the ice and with the handle portion projecting upwardly for ready grasping by the user, such as a bartender. In the context of the present invention, this is of great benefit as the bartender often finds it necessary to fill a glass with ice and subsequently open a bottle of a refreshing beverage, such as a bottle of Coca-Cola® soft drink, prior to filling the ice-bearing glass with the beverage. The present invention permits the filling of a glass with ice and rapid subsequent, opening of a crown-capped bottle and dispensing of the beverage from within the bottle into the glass.

The scoop means 5 is preferably a common scooping means, as such are known in the art, to have a volume sufficient to contain a desired quantity of ice. Within the context of the present invention, the scoop means 5 has a total contained volume of any volume in the range of between about 30 milliliters and 2000 liters, with about 150 milliliters being most preferable for use within a barroom setting.

The bottle opening means 7 is preferably a slot or void in the construction as a whole, as this is the most efficient configuration and is also that which enables an implement according to the invention to be produced at the lowest cost. In this preferred embodiment, there is a lip portion (69, in FIG. 1) which grasps the underside portion of the bottle cap being removed, as such feature is known in the art. However, the present invention includes the use of all other bottle opening means known in the art for removing a pressed-on crown type of beverage bottle cap, as many such implements have been devised over the years. According to an alternate form of the invention, the bottle opening means is a separate construction and is affixed to the handle means by the use of conventional fastening means including screws, rivets, nails, welding, and adhesives.

An implement according to the invention increases the synergistic movements of a server such as a bartender by enabling them to use fewer motions during the procedure of serving a beverage which comprises filling a glass with ice to a desired level and subsequently opening a bottle containing a liquid beverage to be dispensed into the glass, and finally pouring the bottle contents of the bottle into the glass. Heretofore, such process required separate use of two different tools: one to fill the glass with ice; and a second to open the bottle. By eliminating motions associated with the use of two separate tools, bartending is made more efficient through use of the present invention, which will be welcomed by the operators of establishments which serve large numbers of beverage-consuming customers in limited intervals of available time, thus increasing profits to the respective organizations.

Consideration must be given to the fact that although this invention has been shown, described, and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims that now follow.

1) A multipurpose implement comprising:
a) a handle means having an first end portion and a second end portion;
b) a scoop means disposed at said first end portion of said handle means; and
c) a bottle opener means disposed at said second end portion of said handle means.

2) An implement according to claim 1 wherein said bottle opener means comprises a slot disposed at said second end portion.

3) An implement according to claim 2 wherein said bottle opener means is cast-in to the implement as a whole.

4) An implement according to claim 1 wherein said implement is of singular construction.

5) An implement according to claim 1 wherein said implement comprises a metal selected from the group consisting of: aluminum, zinc, copper, tin, and mixtures and alloys of the foregoing.

6) An implement according to claim 4 wherein said implement comprises a metal selected from the group consisting of: aluminum, zinc, copper, tin, and mixtures and alloys of the foregoing.

7) An implement according to claim 1 wherein said implement comprises a polymer selected from the group consisting of: polypropylene, polyethylene, polybutylene, polystyrene, styrene-butadiene-acrylonitrile (SBS), epoxy resins, and alloys of the foregoing.

8) An implement according to claim 4 wherein said implement comprises a polymer selected from the group consisting of: polypropylene, polyethylene, polybutylene, polystyrene, styrene-butadiene-acrylonitrile (SBS), epoxy resins, and alloys of the foregoing.

9) A process for filling a glass with ice and a liquid beverage comprising the steps of:
a) providing an implement comprising:
i) a handle means having an first end portion and a second end portion;
ii) a scoop means disposed at said first end portion of said handle means; and
iii) a bottle opener means disposed at said second end portion of said handle means;
b) obtaining an empty beverage container into which ice and a liquid beverage is intended to be dispensed;
c) filling said scoop means with ice;
d) dispensing ice into said empty beverage container;
e) providing a bottled beverage in a bottle having a crown cap;
f) removing said crown cap from said bottled beverage using said bottle opener means;
g) pouring the beverage from the bottle into said beverage container.

10) A process according to claim 9 wherein said beverage container is a drinking glass.
